(19) United States
(12) Patent Application Publication
(10) Pub. No.: US 2016/0070391 A1
(43) Pub. Date: Mar. 10, 2016

(54) ELECTRONIC DEVICE AND METHOD FOR CONTROLLING DISPLAYED INTERFACE ACCORDING TO POSTURE OF INPUT DEVICE

(71) Applicants: Fu Tai Hua Industry (Shenzhen) Co., Ltd., Shenzhen (CN); HON HAI PRECISION INDUSTRY CO., LTD., New Taipei (TW)

(72) Inventors: YIN ZHANG, Shenzhen (CN); CHIH-HUA HSU, New Taipei (TW)

(21) Appl. No.: 14/716,098

(22) Filed: May 19, 2015

(30) Foreign Application Priority Data
Sep. 5, 2014 (CN) 201410450703.4

(51) Int. Cl. G06F 3/046; G06F 3/038; G06F 3/0354

(52) U.S. Cl. CPC G06F 3/046; G06F 3/03545; G06F 3/038

(57) ABSTRACT

An electronic device and display control method includes a plurality of first receivers and second receivers, respectively to receive first electromagnetic waves and second electromagnetic waves. An input device transmits first and second electromagnetic waves respectively from transmitters at opposite ends of the input device. Programs cause at least one processor to determine an actual first distance and an actual second distance according to the different electromagnetic waves and determine whether the input device is in a certain orientation in relation to the electronic device. The method lights up a backlight device and displays an unlocked interface on a display device if the input device is in the certain orientation.

### CROSS-REFERENCE TO RELATED APPLICATIONS

This application claims priority to Chinese Patent Application No. 201410450703.4 filed on Sep. 5, 2014, the contents of which are incorporated by reference herein.

### FIELD

The subject matter herein generally relates to display control.

### BACKGROUND

Electronic devices can usually be operated by an input device, such as a stylus.

A display device of an electronic device must be unlocked and lit up when operating.

### BRIEF DESCRIPTION OF THE DRAWINGS

The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of an embodiment of an electronic device applying a display control system.

FIG. 2 is a diagrammatic view of an input device and a computing device of FIG. 1.

FIG. 3 is a diagrammatic view of an operation posture of the input device of FIG. 2.

FIG. 4 is a diagrammatic view of an unlocked interface displayed on the computing device of FIG. 1.

FIG. 5 is a diagrammatic view of a locked interface displayed on the computing device of FIG. 1.

FIG. 6 is a flowchart of an embodiment of a display control method for an electronic device, such as the one of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The present disclosure, including the accompanying drawings, is illustrated by way of examples and not by way of limitation. Several definitions that apply throughout this disclosure will now be presented. It should be noted that references to “an” or “one” embodiment in this disclosure are not necessarily to the same embodiment, and such references mean “at least one.”

The term “module” as used hereinafter, refers to logic embodied in hardware or firmware, or to a collection of software instructions, written in a programming language, such as, for example, Java, C, or assembly. One or more software instructions in the modules may be embedded in firmware. It will be appreciated that modules may comprise connected logic modules, such as gates and flip-flops, and may comprise programmable modules, such as programmable gate arrays or processors. The modules described herein may be implemented as either software and/or hardware modules and may be stored in any type of non-transitory computer-readable storage medium or other computer storage device. Some non-limiting examples of non-transitory computer-readable media include CDs, DVDs, BLUE-RAY, flash memory, and hard disk drives. The term “comprising” means “including, but not necessarily limited to”; it specifically indicates open-ended inclusion or membership in a so-described combination, group, series and the like.

The present disclosure is described in relation to an electronic device and display control method. The electronic device includes a plurality of first receivers for receiving first electromagnetic waves and a plurality of second receivers for receiving second electromagnetic waves. Programs in a storage device, executed by at least one processor, cause the at least one processor to determine an actual first distance according to the first electromagnetic waves received by the first receivers, and to determine an actual second distance according to the second electromagnetic waves received by the second receivers. A determination is made as to whether the input device is in a operation posture according to the actual first distance and the actual second distance. The method lights up a backlight device and displays an unlocked interface on a display device if the input device is in the operation posture.

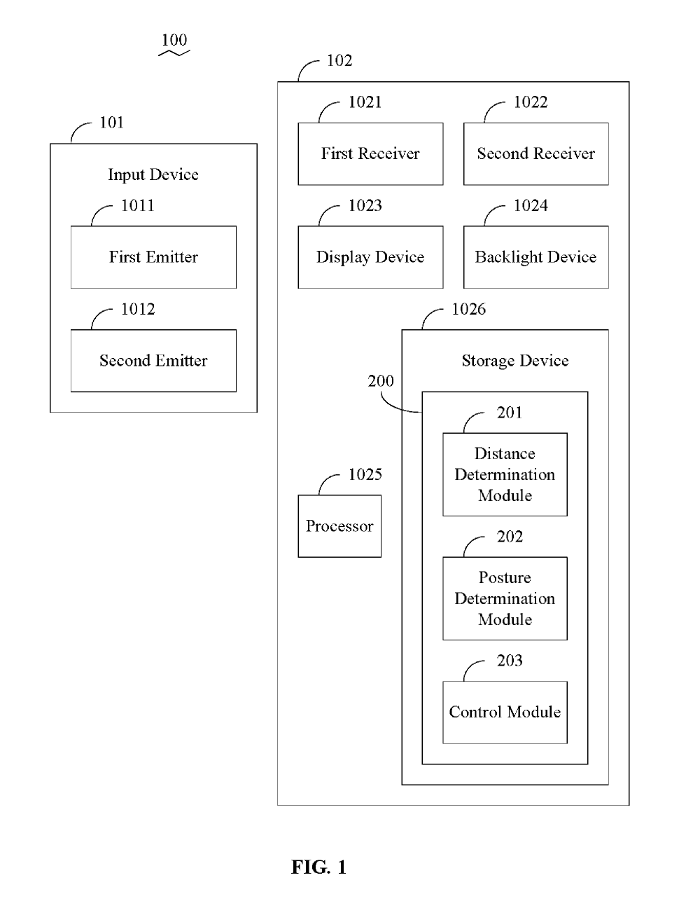

FIG. 1 illustrates an embodiment of an electronic device 100. The electronic device 100 can include an input device 101 and a computing device 102. In at least one embodiment, the input device 101 can be an electronic stylus, such as a capacitive stylus or an electromagnetic stylus. The input device 101 can include a first emitter 1011 and a second emitter 1012.

A display control system 200 is applied to the computing device 102. The computing device 102 can be a mobile phone or a tablet computer, or other portable device. The computing device 102 can include a number of first receivers 1021, a number of second receivers 1022, a display device 1023, and a backlight device 1024. The computing device 102 can also include at least one processor 1025 and a storage device 1026. In at least one embodiment, the computing device 102 includes one processor 1025. The processor 1025 executes instructions of a number of modules stored in the storage device 1026. The storage device 1026 can store a distance determination module 201, a posture determination module 202 and a control module 203.

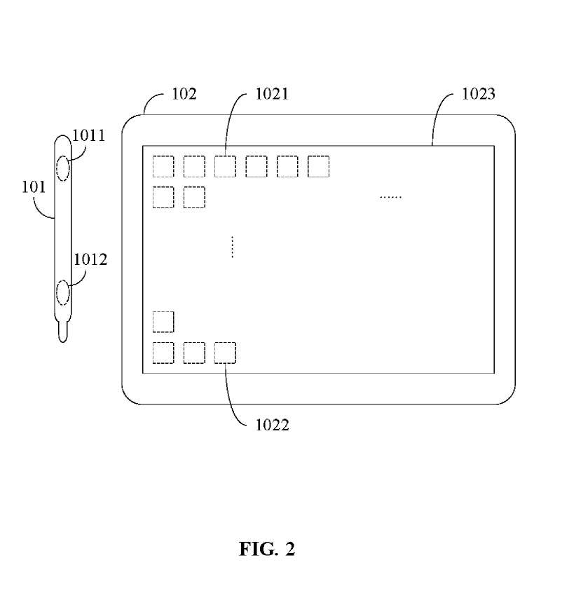

Referring to FIG. 2, the first emitter 1011 and second emitter 1012 are fixed in the input device 101. In at least one embodiment, the first emitter 1011 is fixed in one end, for example an operating end, of the input device 101 and the second emitter 1012 is fixed in the other, opposite end of the input device 101. The first emitter 1011 can emit electromagnetic waves of a first frequency (first electromagnetic waves) and the second emitter 1012 can emit electromagnetic waves of a second frequency (second electromagnetic waves) if a switch on the input device 101 is turned on. In at least one embodiment, the first frequency is different from the second frequency. The number of first receivers 1021 and second receivers 1022 are fixed in the computing device 102. In at least one embodiment, the backlight device 1024 is fixed under the display device 1023, the number of first receivers 1021 and second receivers 1022 are fixed under the backlight device 1024 and uniformly spaced in the computing device 102. The number of first receivers 1021 can receive the first electromagnetic waves and the number of second receivers 1022 can receive the second electromagnetic waves.

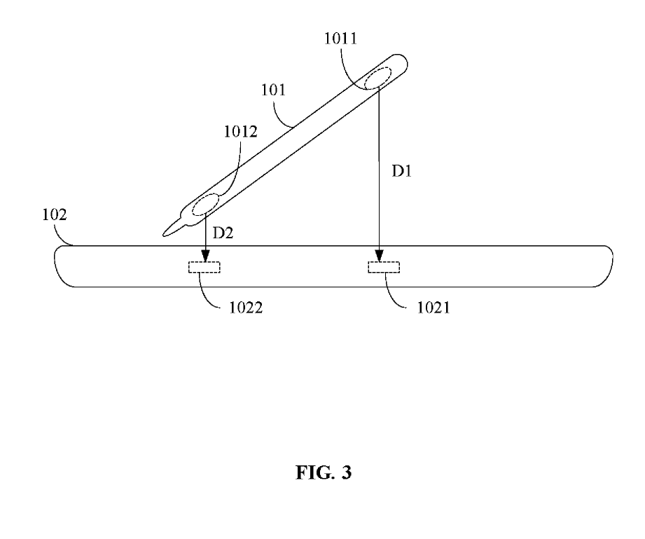

Referring to FIG. 3, the distance determination module 201 can determine first distances between the first emitter 1011 and the first receivers 1021 according to the intensity of the first electromagnetic waves received by the first receivers 1021. The distance determination module 201 can also determine second distances between the second emitter 1012 and the second receivers 1022 according to the intensity of the second electromagnetic waves received by the second receivers 1022. The distance determination module 201 then determines an actual first distance D1 of the first distances and an actual second distance D2 of the second distances. In at least one embodiment, the actual first distance D1 is the smallest value of the first distances and the actual second distance D2 is the smallest value of the second distances. That is to say, the actual first distance D1 is a distance between the first emitter 1011 and the display device 1023 and the actual second distance D2 is a distance between the second emitter 1012 and the display device 1023.

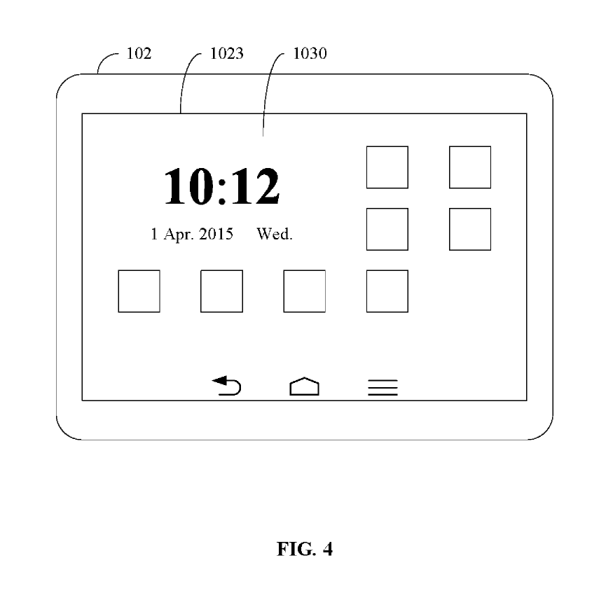

Referring to FIG. 4, the posture determination module 202 determines whether the input device 101 is in a particular orientation in relation to the computing device 102 (hereinafter “operation posture”) based on the actual first distance D1 and the actual second distance D2. In at least one embodiment, if the actual first distance D1 is greater than a preset distance set by a user and the actual second distance is smaller than the preset distance, the posture determination module 202 determines that the input device 101 is in the operation posture. That is, if one end, for example an operating end, is close to the display device 1023 and other end is far from the display device 1023, the posture determination module 202 will determine that the input device 101 is in the operation posture. If the actual first distance D1 and the actual second distance D2 are both greater or both smaller than the preset distance, the posture determination module 202 will determine that the input device 101 is not in the operation posture. If the actual first distance D1 is smaller than the preset distance and the actual second distance D2 is greater than the preset distance, the posture determination module 202 also determines that the input device 101 is not in the operation posture.

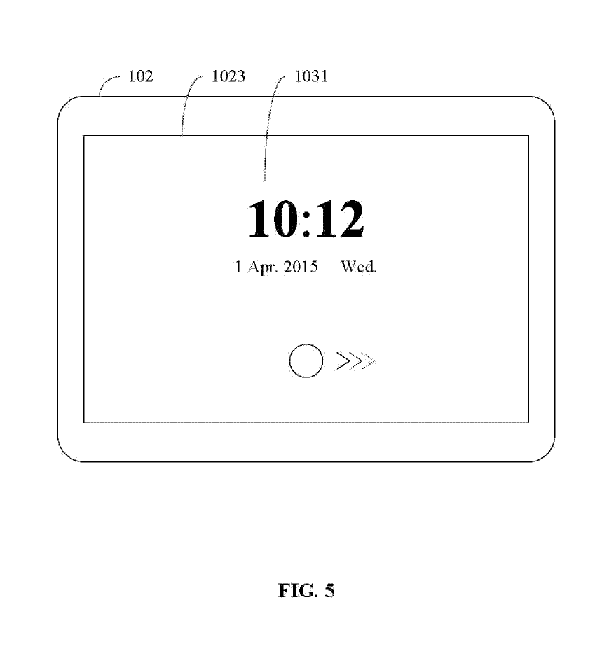

If the input device 101 is in the operation posture, the control module 203 controls the backlight device 1024 to light up and controls the display device 1023 to display an unlocked interface 1030 on which the user can make inputs and carry out operations. If the input device 101 is not in the operation posture, the control module 203 controls the display device 1023 to display a locked interface 1031 as shown in FIG. 5, and further controls the backlight device 1024 to shut down to save energy.

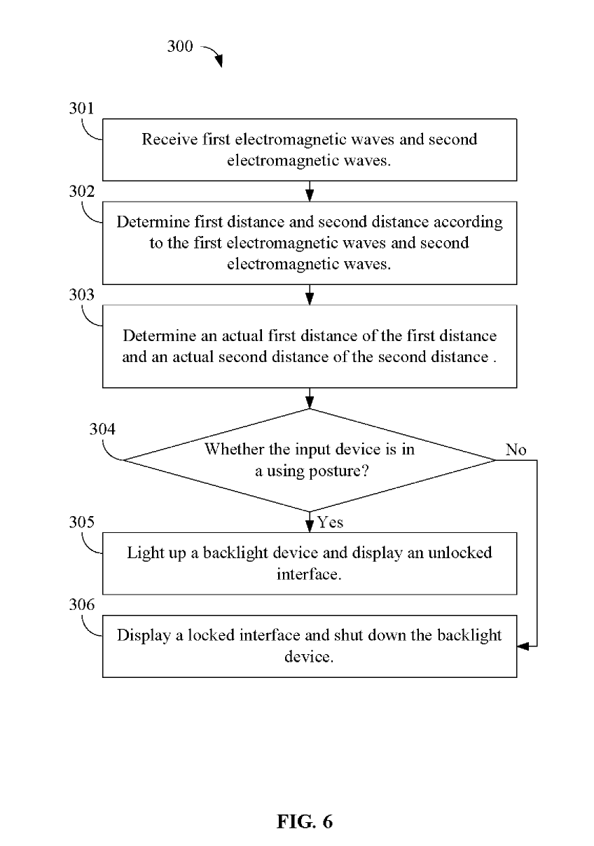

Referring to FIG. 6, a flowchart is presented in accordance with an example embodiment. A method 300 is provided by way of example, as there are varieties of ways to carry out the method. The method 300 described below can be carried out using the configurations illustrated in FIG. 1 and various elements of these figures are referenced in explaining example method 300. Each block shown in FIG. 6 represents one or more processes, methods, or subroutines, carried out in the exemplary method 300. Furthermore, the illustrated order of blocks is by example only and the order of the blocks can be changed. Additional blocks may be added or fewer blocks may be utilized, without departing from this disclosure. The exemplary method 300 can begin at block 301.

At block 301, a first emitter emits first electromagnetic waves and a second emitter emits second electromagnetic waves if a switch on an input device is turned on. A number of first receivers on a computing device receive the first electromagnetic waves and a number of second receivers on the computing device receive the second electromagnetic waves. The first emitter is fixed in one end of the input device and the second emitter is fixed in other end of the input device.

At block 302, a distance determination module determines first distances between the first emitter and the first receivers according to the intensity of the first electromagnetic waves received by the first receivers. The distance determination module determines second distances between the second emitter and the second receivers according to the intensity of the second electromagnetic waves received by the second receivers.

At block 303, the distance determination module determines an actual first distance of the first distances and an actual second distance of the second distances. In at least one embodiment, the actual first distance is the smallest value of the first distances and the actual second distance is the smallest value of the second distances. That is to say, the actual first distance is a distance between the first emitter and the display device and the actual second distance is a distance between the second emitter and the display device.

At block 304, a posture determination module determines whether the input device is in a operation posture based on the actual first distance and the actual second distance. In at least one embodiment, if the actual first distance is greater than a preset distance set by a user and the actual second distance is smaller than the preset distance, the posture determination module determines that the input device is in the operation posture. If the actual first distance and the actual second distance are both greater or both smaller than the preset distance, the posture determination module determines that the input device is not in the operation posture. If the actual first distance is smaller than the preset distance and the actual second distance is greater than the preset distance, the posture determination module also determines that the input device is not in the operation posture. If the input device is in the operation posture, block 305 is implemented. If the input device is not in the operation posture, block 306 is implemented.

At block 305, a control module controls a backlight device to light up and controls a display device to display an unlocked interface on which the user can operate.

At block 306, the control module controls the display device to display a locked interface and the backlight device to shut down to save energy.

The embodiments shown and described above are only examples. Many details are often found in the art such as the other features of an electronic device and method for controlling displayed interface according to posture of input device. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure, up to and including the full extent established by the broad general meaning of the terms used in the claims.

What is claimed is:

1. An electronic device comprising:
an input device comprising:
a first emitter which emits a plurality of first electromagnetic waves;
a second emitter which emits a plurality of second electromagnetic waves;
a computing device comprising:
a plurality of first receivers configured to receive the plurality of first electromagnetic waves;
a plurality of second receivers configured to receive the plurality of second electromagnetic waves;
at least one processor;
a non-transitory storage device coupled to the at least one processor and storing one or more programs, which when executed by the at least one processor, cause the at least one processor to:
determine an actual first distance according to the first electromagnetic waves received by the first receivers, determine an actual second distance according to the second electromagnetic waves received by the second receivers;
determine whether the input device is oriented in an operation posture according to the actual first distance and the actual second distance; and
light up a backlight device and display an unlocked interface on a display device if the input device is in the operation posture.

2. The electronic device of claim 1, wherein frequency of the first electromagnetic waves is different from frequency of the second electromagnetic waves.

3. The electronic device of claim 1, wherein in “determine an actual first distance according to the first electromagnetic waves received by the first receivers, determine an actual second distance according to the second electromagnetic waves received by the second receivers”, the at least one processor is to further:
determine first distances between the first emitter and the first receivers according to the intensity of the first electromagnetic waves received by the first receivers, determine second distances between the second emitter and the second receivers according to the intensity of the second electromagnetic waves received by the second receivers; and
determine a smallest value of the first distances as the actual first distance, determine a smallest value of the second distances as the actual second distance.

4. The electronic device of claim 1, wherein in “determine whether the input device is in a operation posture according to the actual first distance and the actual second distance”, the at least one processor is to further:
determine that the input device is in the operation posture if the actual first distance is greater than a preset distance and the actual second distance is smaller than the preset distance.

5. The electronic device of claim 4, wherein the one or more programs cause the at least one processor to further:
determine that the input device is not in the operation posture if:
the actual first distance is smaller than the preset distance and the actual second distance is greater than the preset distance; or
the actual first distance and the actual second distance is both greater than the preset distance; or
the actual first distance and the actual second distance is both smaller than the preset distance; and
display a locked interface on the display device and shut down the backlight device.

6. A computer-based method for controlling display for an electronic device being executed by at least one processor of the electronic device, the method comprising:
receiving first electromagnetic waves emitted from a first emitter and second electromagnetic waves emitted from a second emitter;
determining an actual first distance according to the first electromagnetic waves received by the first receivers, determining an actual second distance according to the second electromagnetic waves received by the second receivers;
determining whether the input device is in an operation posture according to the actual first distance and the actual second distance; and
lighting up a backlight device and displaying an unlocked interface on a display device if the input device is in the operation posture.

7. The method of claim 6, wherein frequency of the first electromagnetic waves is different from frequency of the second electromagnetic waves.

8. The method of claim 6, wherein in “determining an actual first distance according to the first electromagnetic waves received by the first receivers, determining an actual second distance according to the second electromagnetic waves received by the second receivers”, the method comprising:
determining first distances between the first emitter and the first receivers according to the intensity of the first electromagnetic waves received by the first receivers, determining second distances between the second emitter and the second receivers according to the intensity of the second electromagnetic waves received by the second receivers; and
determining a smallest value of the first distances as the actual first distance, determining a smallest value of the second distances as the actual second distance.

9. The method of claim 6, wherein in “determining whether the input device is in a operation posture according to the actual first distance and the actual second distance”, the method comprising:
determining that the input device is in the operation posture if the actual first distance is greater than a preset distance and the actual second distance is smaller than the preset distance.

10. The method of claim 9, wherein the method comprising:
determining that the input device is not in the operation posture if:
the actual first distance is smaller than the preset distance and the actual second distance is greater than the preset distance, or
the actual first distance and the actual second distance is both greater than the preset distance; or
the actual first distance and the actual second distance is both smaller than the preset distance; and
displaying a locked interface on the display device and shutting down the backlight device.

11. A non-transitory storage device having stored thereon instructions that, when executed by a processor of an electronic device, causes the processor to perform a display control method, wherein the method comprises:
receiving first electromagnetic waves emitted from a first emitter and second electromagnetic waves emitted from a second emitter;
determining an actual first distance according to the first electromagnetic waves received by the first receivers, determining an actual second distance according to the second electromagnetic waves received by the second receivers;
determining whether the input device is in an operation posture according to the actual first distance and the actual second distance; and
lighting up a backlight device and displaying an unlocked interface on a display device if the input device is in the operation posture.

12. The non-transitory storage device according to claim 11, wherein frequency of the first electromagnetic waves is different from frequency of the second electromagnetic waves.

13. The non-transitory storage device according to claim 11, wherein in “determining an actual first distance according to the first electromagnetic waves received by the first receivers, determining an actual second distance according to the second electromagnetic waves received by the second receivers”, the method comprising:
determining first distances between the first emitter and the first receivers according to the intensity of the first electromagnetic waves received by the first receivers, determining second distances between the second emitter and the second receivers according to the intensity of the second electromagnetic waves received by the second receivers; and
determining a smallest value of the first distances as the actual first distance, determining a smallest value of the second distances as the actual second distance.

14. The non-transitory storage device according to claim 11, wherein in “determining whether the input device is in a operation posture according to the actual first distance and the actual second distance”, the method comprising:
determining that the input device is in the operation posture if the actual first distance is greater than a preset distance and the actual second distance is smaller than the preset distance.

15. The non-transitory storage device according to claim 14, wherein the method comprising:
determining that the input device is not in the operation posture if:
the actual first distance is smaller than the preset distance and the actual second distance is greater than the preset distance, or
the actual first distance and the actual second distance is both greater than the preset distance; or
the actual first distance and the actual second distance is both smaller than the preset distance; and
displaying a locked interface on the display device and shutting down the backlight device.
